(19) United States
(12) Patent Application Publication
(10) Pub. No.: US 2017/0008342 A1
(43) Pub. Date: Jan. 12, 2017

(54) NON-PNEUMATIC TIRE INCLUDING SHEAR BAND

(71) Applicant: CATERPILLAR INC., PEORIA, IL (US)

(72) Inventors: KEVIN L. MARTIN, WASHBURN, IL (US); JASON G. JURA, PEORIA, IL (US)

(73) Assignee: CATERPILLAR INC., PEORIA, IL (US)

(21) Appl. No.: 14/796,246

(22) Filed: Jul. 10, 2015

(51) Int. Cl. B60C 7/14

(52) U.S. Cl. CPC B60C 7/14; B60C 2007/107

(57) ABSTRACT

A non-pneumatic tire may include an inner circumferential barrier configured to be associated with a hub, and an outer circumferential barrier. The tire may also include a plurality of spokes extending between the inner and outer circumferential barriers, and a shear band radially exterior relative to the outer circumferential barrier. The shear band may include an internal tension band associated with the outer circumferential barrier including at least one circumferentially extending reinforcement cord. The shear band may also include an external compression band including at least one circumferentially extending reinforcement cord. The shear band may further include at least one shear module extending between the internal tension band and the external compression band. The shear module may include at least one shear module including a first reinforcement element, a second reinforcement element, and a separator between the first reinforcement element and the second reinforcement element.

### TECHNICAL FIELD

The present disclosure relates to non-pneumatic tires, and more particularly, to non-pneumatic tires including a shear band.

### BACKGROUND

Machines such as vehicles, either self-propelled or pushed or pulled, often include wheels for facilitating travel across terrain. Such wheels often include a tire to protect a rim or hub of the wheel, provide cushioning for improved comfort or protection of the operator, passengers or cargo, and provide enhanced traction via a tread of the tire. Non-pneumatic tires are an example of such tires.

Non-pneumatic tires, such as solid tires or tires not retaining pressurized air or gas, may have advantages relative to pneumatic tires because they do not retain air or gas under pressure. However, non-pneumatic tires may suffer from a number of possible drawbacks. For example, non-pneumatic tires may be relatively heavy and may not have a sufficient ability to provide a desired level of cushioning. For example, some non-pneumatic tires may provide little, if any, cushioning, potentially resulting in discomfort for an operator and passengers and/or damage to cargo. In addition, some non-pneumatic tires may not be able to maintain a desired level of cushioning when the load changes on the tire. In particular, if the structure of the non-pneumatic tire provides the desired level of cushioning for a given load, it may not be able to continue to provide the desired level of cushioning if the load is changed. For example, if the load is increased, the structure of the non-pneumatic tire may collapse, resulting in a loss of the desired level of cushioning or potentially damaging the tire. If the load is decreased, the level of cushioning may also decrease, resulting in an undesirable reduction in comfort and/or protection. In addition, conventional non-pneumatic tires that provide adequate cushioning may not be able to maintain the desired vehicle ride height when loaded due to collapse of the tire under load. Thus, it may be desirable to provide a non-pneumatic tire that provides a desired combination of cushioning and support.

An example of a non-pneumatic wheel is disclosed in U.S. Pat. No. 8,962,120 B2 to Delfino et al. (“the '120 patent”). In particular, the '120 patent discloses a non-pneumatic resilient wheel including a hub, an annular shear band including an inner circumferential membrane and an outer circumferential membrane, and a plurality of support elements that connect the hub to the inner circumferential membrane. The two membranes are connected to one another in anchoring zones by means of a series of connecting cylindrical structures. Each connecting cylindrical structure includes a plurality of elementary cylinders fitted one inside the other and interconnected to one another in each anchoring zone.

Although the non-pneumatic wheel disclosed in the '120 patent provides a non-pneumatic wheel purportedly able to operate in a wide variety of temperatures and prevent separation of various portions of the wheel from one another, it may suffer from a number of drawbacks associated with non-pneumatic tires. For example, the wheel disclosed in the '120 patent may not be able to maintain a desired level of cushioning when the load on the wheel changes. Further, the wheel is relatively complex and may be difficult to manufacture on a large scale due to the mechanical interconnections between parts, for example, in the anchoring zones.

The non-pneumatic tires disclosed herein may be directed to mitigating or overcoming one or more of the possible drawbacks set forth above.

### SUMMARY

In one aspect, the present disclosure is directed to a non-pneumatic tire. The tire may include an inner circumferential barrier configured to be associated with a hub, and an outer circumferential barrier radially exterior relative to the inner circumferential barrier. The tire may also include a plurality of spokes extending between the inner circumferential barrier and the outer circumferential barrier, and a shear band radially exterior relative to the outer circumferential barrier and radially interior relative to a tread portion of the tire. The shear band may include an internal tension band associated with the outer circumferential barrier, wherein the internal tension band extends circumferentially around the outer circumferential barrier and includes at least one circumferentially extending reinforcement cord. The shear band may also include an external compression band radially spaced from and exterior relative to the internal tension band, wherein the external compression band includes at least one circumferentially extending reinforcement cord. The shear band may further include at least one shear module extending between a radially external surface of the internal tension band and a radially internal surface of the external compression band. The at least one shear module may include a first reinforcement element, a second reinforcement element, and a separator between the first reinforcement element and the second reinforcement element.

In another aspect, a wheel includes a hub configured to be coupled to a machine, and a non-pneumatic tire coupled to the hub. The tire may include an inner circumferential barrier coupled to the hub, and an outer circumferential barrier radially exterior relative to the inner circumferential barrier. The tire may also include a plurality of spokes extending between the inner circumferential barrier and the outer circumferential barrier, and a shear band radially exterior relative to the outer circumferential barrier and radially interior relative to a tread portion of the tire. The shear band may include an internal tension band associated with the outer circumferential barrier, wherein the internal tension band extends circumferentially around the outer circumferential barrier and includes at least one circumferentially extending reinforcement cord. The shear band may also include an external compression band radially spaced from and exterior relative to the internal tension band, wherein the external compression band includes at least one circumferentially extending reinforcement cord. The shear band may further include at least one shear module extending between a radially external surface of the internal tension band and a radially internal surface of the external compression band. The at least one shear module may include a first reinforcement element, a second reinforcement element, and a separator between the first reinforcement element and the second reinforcement element.

### BRIEF DESCRIPTION OF THE DRAWINGS

FIG. 1 is a perspective view of an exemplary embodiment of a wheel including an exemplary embodiment of a non-pneumatic tire.

FIG. 2 is a side view of the exemplary wheel shown in FIG. 1.

FIG. 3 is a detailed side view of the exemplary wheel shown in FIG. 1.

FIG. 4 is a detailed, partial perspective section view of an exemplary embodiment of a non-pneumatic tire.

FIG. 5 is a partial section view of an exemplary embodiment of a shear band shown straightened for clarity.

FIG. 6 is a cross-sectional view of an exemplary embodiment of a reinforcement cord.

FIG. 7 is a cross-sectional view of an exemplary embodiment of a shear module.

FIG. 8 is a partial section view of another exemplary embodiment of a shear band shown straightened for clarity.

FIG. 9 is a partial section view of a further exemplary embodiment of a shear band shown straightened for clarity.

FIG. 10 is a partial section view of another exemplary embodiment of a shear band shown straightened for clarity.

FIG. 11 is a partial section view of a further exemplary embodiment of a shear band shown straightened for clarity.

### DETAILED DESCRIPTION

The exemplary tires disclosed herein may be used, for example, for machines configured to travel across terrain. An example of such a machine is a wheel loader. However, the machines may include any type of ground-borne vehicle, such as, for example, an automobile, a truck, an agricultural vehicle, and/or a construction vehicle, such as, for example, a dozer, a skid-steer loader, an excavator, a grader, an on-highway truck, an off-highway truck, and/or any other vehicle type known to a person skilled in the art. In addition to self-propelled machines, machines may be any device configured to travel across terrain via assistance or propulsion from another machine.

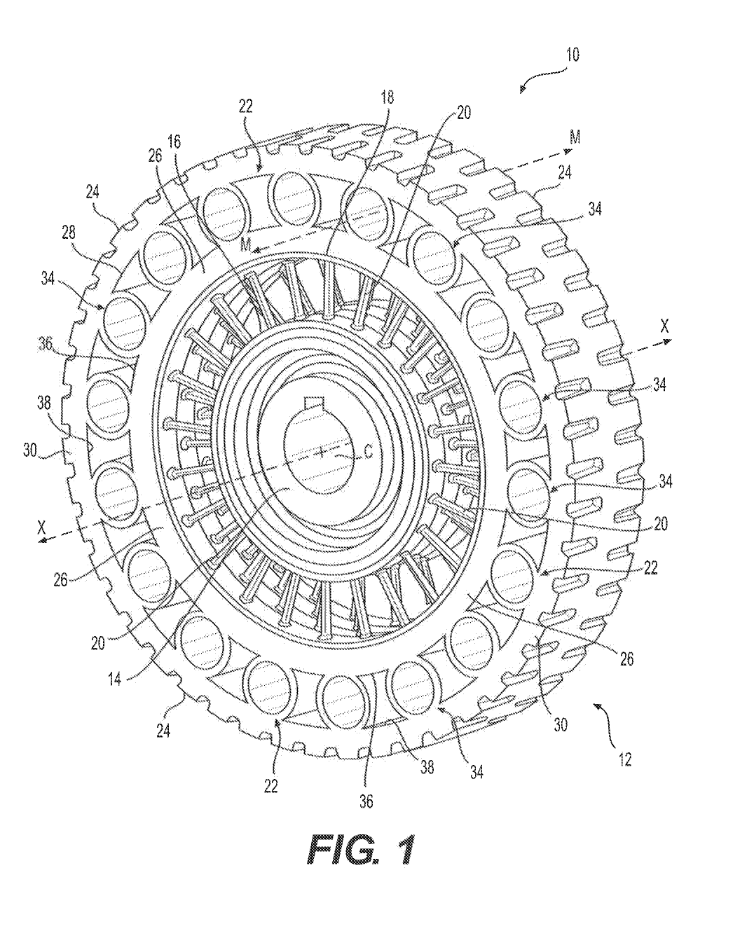

FIG. 1 shows an exemplary embodiment of a wheel 10 including an exemplary embodiment of a non-pneumatic tire 12. As shown in FIG. 1, exemplary wheel 10 includes a hub 14 configured to be coupled to a machine, for example, to a powertrain of a machine.

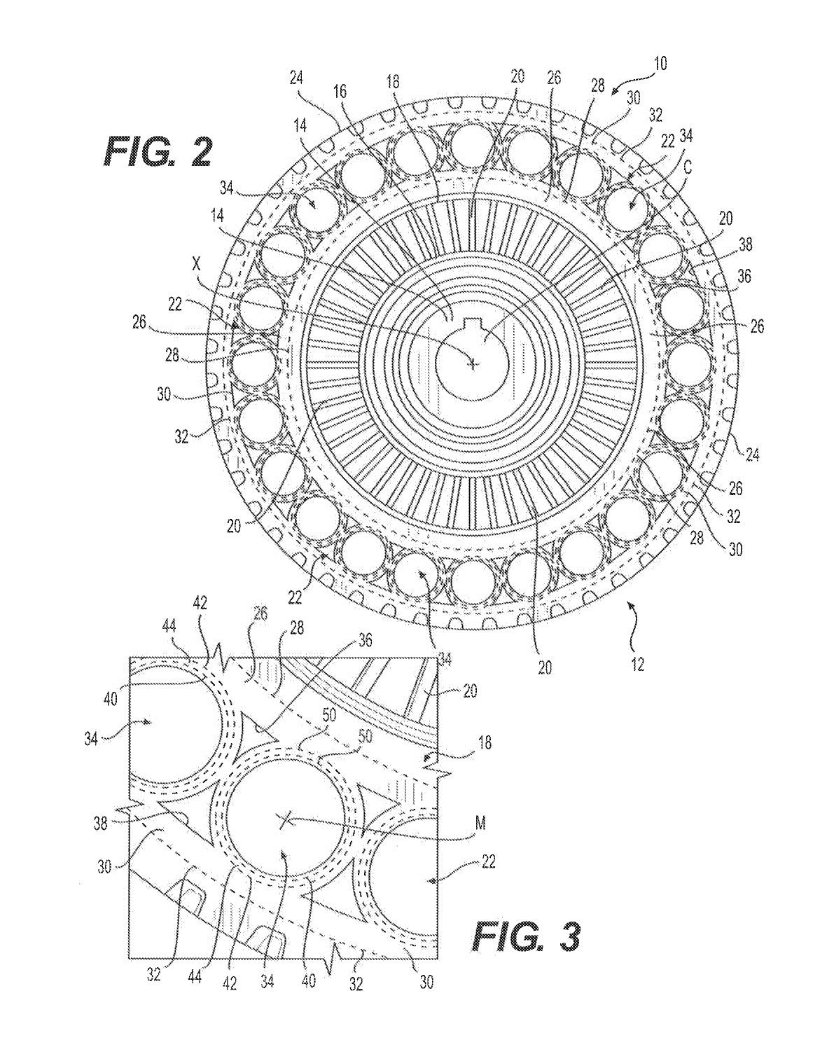

Exemplary tire 12 shown in FIGS. 1 and 2 includes an inner circumferential barrier 16 configured to be coupled to hub 14, and an outer circumferential barrier 18 radially spaced from, and radially exterior relative to, inner circumferential barrier 16. Exemplary tire 12 also includes a plurality of spokes 20 extending between inner circumferential barrier 16 and outer circumferential barrier 18. For example, in the exemplary embodiments shown, spokes 20 extend radially (i.e., in a direction parallel to radial lines extending away from a center C of tire 12) and couple inner circumferential barrier 16 and outer circumferential barrier 18 to one another. Hub 14 and/or inner circumferential barrier 16 may be configured to facilitate coupling of hub 14 to inner circumferential barrier 16, so that torque may be transferred between hub 14 and inner circumferential barrier 16.

Exemplary tire 12 also includes a shear band 22 radially exterior relative to outer circumferential barrier 18 and radially interior relative to a tread portion 24 of tire 12. Tread portion 24 of tire 12 may be configured to improve traction of tire 12 at the interface between tire 12 and the terrain across which tire 12 rolls about an axis of rotation X.

According to some embodiments, inner circumferential barrier 16, spokes 20, outer circumferential barrier 18, shear band 22, and/or tread portion 24 may be integrally formed as a single, monolithic piece, for example, via molding. However, it is also contemplated that inner circumferential barrier 16, spokes 20, outer circumferential barrier 18, shear band 22, and/or tread portion 24 may be formed separately and thereafter coupled to one another via adhesives and/or mechanical methods (e.g., via fasteners and/or complementary portions on adjacent parts). According to some embodiments, one or more of inner circumferential barrier 16, spokes 20, outer circumferential barrier 18, shear band 22, and tread portion 24 may be pre-formed and placed together in a mold that is heated to cure the tire 12 as a single piece. For example, one or more of inner circumferential barrier 16, spokes 20, outer circumferential barrier 18, shear band 22, and tread portion 24 may be green-cured (i.e., heated a sufficient amount to be partially cured) and thereafter placed in the mold together and heated to a sufficient temperature and for a sufficient duration to complete the curing process.

Tire 12 may be configured to provide a desired amount of traction and cushioning between a machine supported by one or more tires 12 and the terrain. For example, inner circumferential barrier 16, spokes 20, outer circumferential barrier 18, shear band 22, and tread portion 24 may be configured to support a machine in a loaded, partially loaded, and empty condition, such that a desired amount of traction and/or cushioning is provided for the machine, regardless of the load.

For example, if the machine is a wheel loader, when a bucket of the wheel loader is empty, the load on one or more of wheels 10 may range from about 60,000 lbs. to about 160,000 lbs. (e.g., 120,000 lbs.) In contrast, with the bucket loaded with material, the load on one or more of wheels 10 may range from about 200,000 lbs. to about 400,000 lbs. (e.g., 350,000 lbs.). Tire 12 may be configured to provide a desired level of traction and cushioning, regardless of whether the bucket is loaded, partially loaded, or empty. For smaller machines, correspondingly lower loads are contemplated. For example, for a skid-steer loader, the load on one or more of wheels 10 may range from about 1,000 lbs. empty to about 3,000 lbs. (e.g., 2,400 lbs.) loaded.

According to some embodiments, tire 12 may be configured such that it responds to load in a manner similar to a tension wheel. For example, load supported by tire 12 at hub 14 is supported primarily in tension rather than primarily in compression. Referring to FIG. 2, for example, a load supported by tire 12 acts at hub 14, which, in turn, acts on inner circumferential barrier 16. Inner circumferential barrier 16 pulls downward (as shown in FIG. 2) on spokes 20 located above hub 14, such that spokes 20 above hub 14 are in tension. In contrast, spokes 20 located below hub 14 support relatively little, if any, of the load, which would be in compression. Thus, outer circumferential barrier 18, shear band 22, and tread portion 24 located above hub 14, support the load on hub 14 via spokes 20 located above hub 14 primarily in tension.

As shown in FIGS. 2-4, exemplary shear band 22 includes an internal tension band 26 associated with outer circumferential barrier 18. Exemplary internal tension band 26 extends circumferentially around outer circumferential barrier 18 and includes at least one circumferentially extending reinforcement cord 28. According to some embodiments, internal tension band 26 may be configured to be at least partially in tension when a load is applied at hub 14. Exemplary shear band 22 also includes an external compression band 30 radially spaced from and exterior relative to internal tension band 26. Exemplary external compression band 30 includes at least one circumferentially extending reinforcement cord 32. According to some embodiments, external compression band 30 may be configured to be at least partially in compression when a load is applied at hub 14.

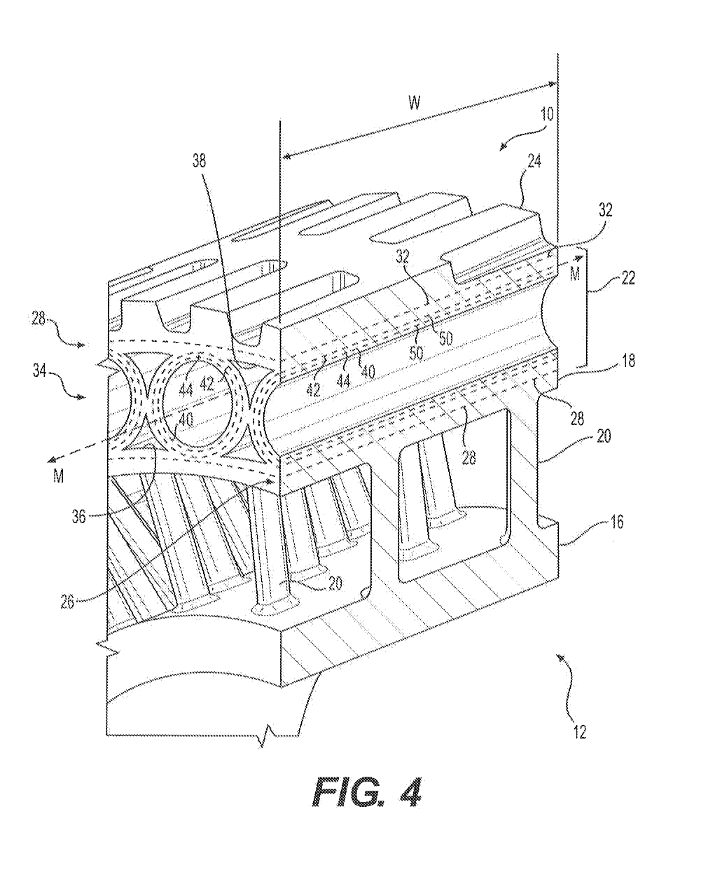

As shown in FIGS. 2-4, exemplary shear band 22 also includes at least one shear module 34 extending between a radially external surface 36 of internal tension band 26 and a radially internal surface 38 of external compression band 30. Exemplary shear module 34 shown in FIGS. 2 and 4 includes a first reinforcement element 40, a second reinforcement element 42, and a separator 44 between first reinforcement element 40 and second reinforcement element 42. According to some embodiments, separator 44 is coextensive (e.g., axially coextensive) with first reinforcement element 40 and second reinforcement element 42. According to some embodiments, separator 44 serves to prevent first reinforcement element 40 and second reinforcement element 42 from contacting one another. In the exemplary embodiment shown in FIGS. 2-4, exemplary shear module 34 is in the form of an elongated tubular element having a circular cross-section parallel to an equatorial plane of tire 12 that is perpendicular to axis of rotation X (see FIG. 1), such that shear module 34 has a longitudinal axis M extending substantially parallel to axis of rotation X. It is contemplated that shear module 34 may have different forms.

According to some embodiments, shear band 22 including shear module 34 may be configured to serve one or more of several possible functions. For example, shear band 22 may be configured to provide a relatively more rigid hoop-shaped structure adjacent tread portion 24. This may provide more support for a load applied to hub 14 by a machine, with spokes 20 above hub 14 supporting the load in tension as spokes 20 extend between inner circumferential barrier 16 and outer circumferential barrier 18. Shear band 22 may also be configured to reduce the weight of tire 12, particularly in the outer circumferential portion of tire 12. Because shear band 22, for example, in the exemplary embodiments shown, is located in the outer circumferential portion of tire 12 to provide support adjacent tread portion 24, a solid or substantially solid shear band would require a substantial amount of material, adding significant weight and hence significant rotational inertia to the tire.

According to some embodiments, internal tension band 26 of shear band 22 may include a plurality of reinforcement cords 28, and/or external compression band 30 of shear band 22 may include a plurality of reinforcement cords 32. For example, as shown in FIG. 4, reinforcement cords 28 and reinforcement cords 32 may be present axially across the width W of tire 12. According to some embodiments, reinforcement cords 28 and/or 32 may be a single cord spirally-wrapped circumferentially within internal tension band 26 and/or external compression band 30, such that reinforcement cords 28 and/or 32 extend circumferentially around outer circumferential barrier 18. In addition, as shown in FIG. 6, one or more (e.g., each) of reinforcement cords 30 and 32 may include a wire rope 46 including a plurality of spirally-wrapped wires 48. Reinforcement cords 30 and/or 32, wire rope 46, and/or wires 48 may be formed from any material having a relatively high tensile strength, such as, for example, steel, stainless, steel, aramid fiber, KEVLAR®, carbon fiber, polymer fiber, and/or any combinations thereof.

According to some embodiments, at least one of first reinforcement element 40 and second reinforcement element 42 of shear module 34 includes at least one module reinforcement cord 50. For example, as shown in FIGS. 2-5, both first reinforcement element 40 and second reinforcement element 42 include at least one module reinforcement cord 50. As shown in FIG. 4, both exemplary first reinforcement element 40 and second reinforcement element 42 may include a plurality of module reinforcement cords 50 may be present axially across width W of tire 12. According to some embodiments, reinforcement elements 40 and/or 42 may be a single cord spirally-wrapped circumferentially within shear module 34. As shown in FIG. 6, one or more (e.g., each) of module reinforcement cords 50 may include a wire rope 46 including a plurality of spirally-wrapped wires 48. Module reinforcement cords 50, wire rope 46, and/or wires 48 may be formed from any material having a relatively high tensile strength, such as, for example, steel, stainless, steel, aramid fiber, KEVLAR®, carbon fiber, polymer fiber, and/or any combinations thereof.

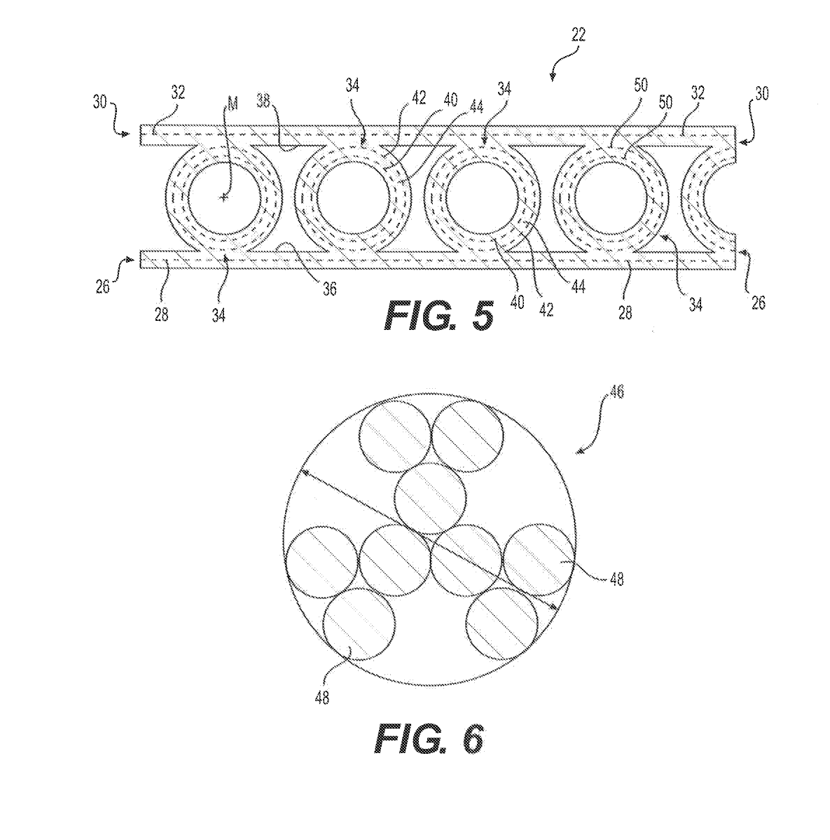

According to the exemplary embodiment shown in FIGS. 1-4, tire 12 includes a plurality of shear modules 34, and the plurality of shear modules 34 are positioned circumferentially about tire 12. According to some embodiments, at least some of the plurality of shear modules 34 are circumferentially spaced from one another about tire 12, for example, such that one or more of shear modules 34 do not contact another one of the plurality of shear modules 34, for example, as shown in FIG. 5, which shows an exemplary shear band 22 in a straightened form (rather than circular form) for clarity. According to some embodiments, at least some of circumferentially adjacent shear modules 34 contact one another, for example, as shown in FIGS. 2-4. For example, each of shear modules 34 may contact two adjacent shear modules 34 located on circumferentially opposite sides of a shear module 34. According to some embodiments, shear modules 34 that contact circumferentially adjacent shear modules 34 may result in a relatively more rigid shear band 22 than a shear band 22 where adjacent shear modules 34 do not contact another shear module 34.

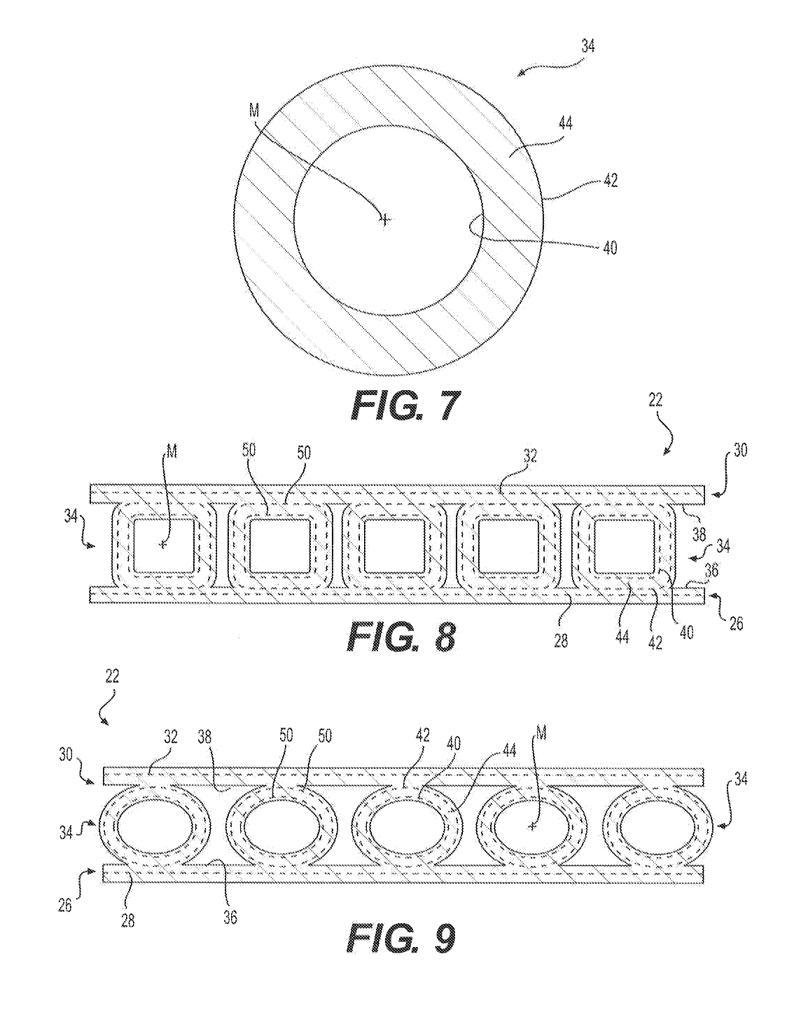

As shown in FIGS. 1-5 and 7-9, some embodiments include shear modules 34 that are tubular and have a longitudinal axis M extending transverse to an equatorial plane of the tire perpendicular to axis of rotation X of tire 12. For example, FIGS. 5, 7, 8, and 9 show exemplary shear modules 34 having a circular cross-section (FIGS. 5 and 7), a square-shaped cross-section (FIG. 8, and an elliptical- or oval-shaped cross-section (FIG. 9). Shear modules 34 having different cross-sectional shapes are contemplated. For example, according to some embodiments one or more of shear modules 34 may have a cross-section parallel relative to the equatorial plane that is polygonal-shaped.

In the exemplary embodiments shown, first reinforcement element 40 is interior relative to separator 44, and second reinforcement element 42 is exterior relative to separator 44. According to some embodiments, at least one of first reinforcement element 40 and second reinforcement element 42 is encapsulated. For example, in the exemplary embodiments shown in FIGS. 4 and 5, first reinforcement element 40 is covered with material (e.g., polyurethane or similar material) on a side opposite separator 44, and second reinforcement element 42 is covered with material (e.g., polyurethane or similar material) on a side opposite separator 44, such that first reinforcement element 40 and second reinforcement element 42 are encapsulated.

According to some embodiments, at least one of first reinforcement element 40 and second reinforcement element 42 are not encapsulated. For example, as shown in FIG. 7, first reinforcement element 40 and second reinforcement element 42 are not covered with material, except by the material of exemplary separator 44. Thus, the exteriors of first reinforcement element 40 and second reinforcement element 42 are exposed. According to some embodiments, first and/or second reinforcement elements 40 and 42 shown in FIG. 7 may be tubular elements, such as, for example, steel tubular elements sandwiching separator 44. According to some embodiments, first and/or second reinforcement elements 40 and 42 may be a spirally-wrapped wire, such as, for example, a wire at least similar to wire rope 46 shown in FIG. 6.

According to some embodiments, at least one of first reinforcement element 40 and second reinforcement element 42 includes at least one module reinforcement cord 50. For example, the at least one module reinforcement cord 50 may be spirally-wrapped with respect to separator 44. According to some embodiments, first reinforcement element 40 and second reinforcement element 42 each include at least one module reinforcement cord 50, for example, a spirally-wrapped wire, such as, for example, a wire at least similar to wire rope 46 shown in FIG. 6. According to some embodiments, first reinforcement element 40 and second reinforcement element 42 may include a reinforcement cord wrapped around the interior and exterior of separator 44.

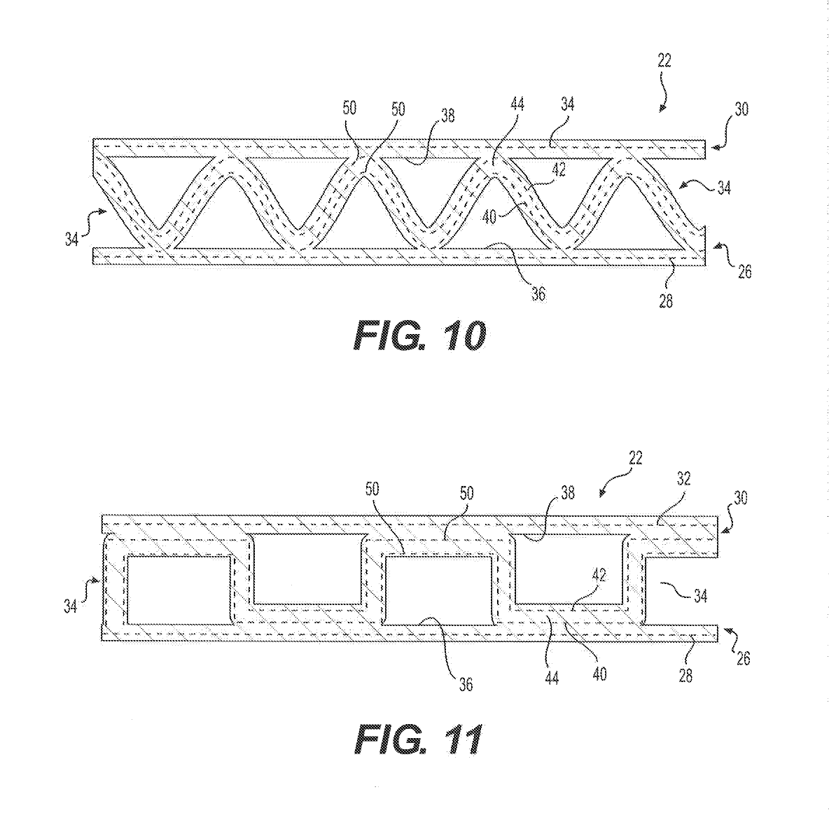

As shown in FIGS. 10 and 11, shear band 34 may include a single shear module 34 (shown straightened for clarity), and shear module 34 intermittently (e.g., alternatingly) contacts radially external surface 36 of internal tension band 26 and radially internal surface 38 of external compression band 30. For example, exemplary shear modules 34 shown in FIGS. 10 and 11 each form a waveform as shear module 34 extends between radially external surface 36 of internal tension band 26 and radially internal surface 38 of external compression band 30. The waveform may include at least one of a sine waveform, a square waveform, and a triangular waveform. Other waveforms are contemplated.

As shown in FIGS. 1 and 4, according to some embodiments, each of spokes 20 extends radially (i.e., in a direction parallel to a radial direction extending away from center C of tire 12). In the exemplary embodiment shown, spokes 20 do not extend in the axial direction parallel to axis of rotation X across the entire width W of tire 12. Rather, they have an axial width smaller than width W of tire 12. In the exemplary embodiment shown, at least some of the plurality of spokes 20 are located at different axial locations of tire 12. For example, in the axial direction some of spokes 20 are coupled to inner circumferential barrier 16 and outer circumferential barrier 18 at an axial location different to the axial locations at which other spokes 20 are coupled to inner circumferential barrier 16 and outer circumferential barrier 18.

According to some embodiments, at least one of inner circumferential barrier 16, outer circumferential barrier 18, at least some of the plurality of spokes 20, internal tension band 26, external compression band 30, the at least one shear module 34, and tread portion 24 may be at least partially formed from an elastically deformable material, such as, for example, at least one polymer selected from the group consisting of polyurethane, natural rubber, synthetic rubber, and combinations thereof. According to some embodiments, different parts of tire 12 may be formed from different materials. For example, inner circumferential barrier 16, outer circumferential barrier 18, at least some of the plurality of spokes 20, internal tension band 26, external compression band 30, and/or the at least one shear module 34 may be formed from a first material, and tread portion 24 may be formed from a second material. For such embodiments, one or more of inner circumferential barrier 16, outer circumferential barrier 18, at least some of the plurality of spokes 20, internal tension band 26, external compression band 30, the at least one shear module 34, tread portion 24, and/or other parts of tire 12 may be formed separately from one another, and may be coupled or joined to one another via known methods, such as, for example, mechanical fastening and/or adhesives. According to some embodiments, inner circumferential barrier 16, outer circumferential barrier 18, at least some of the plurality of spokes 20, internal tension band 26, external compression band 30, the at least one shear module 34, and tread portion 24 may be formed together as a single piece, for example, via molding.

According to some embodiments, tread portion 24 may be formed from a material different from other portions of tire 12, such that tread portion 24 exhibits different characteristics than the other portions. For example, a second material forming tread portion 24 may provide tread portion 24 with more wear resistance, abrasion resistance, hardness, toughness, and/or a different appearance (e.g., color or texture) than materials used to form other portions of tire 12. According to some embodiments, spokes 20 may be formed from a material having a higher tensile strength than other portions of tire 12.

According to some embodiments, shear band 22 may be formed separately from the other portions of tire 12 and thereafter incorporated into, or coupled to, the other portions of tire 12. For example, shear band 22 may be pre-formed and thereafter placed into a mold for forming other portions of tire 12, with other portions of tire 12 being molded around shear band 22. According to some embodiments, shear modules 34 may be formed separately from the other portions of tire 12 and thereafter incorporated into, or coupled to, the other portions of tire 12. For example, shear modules 34 may be pre-formed and thereafter placed into a mold for forming other portions of tire 12, with other portions of tire 12 being molded around shear modules 34. According to some embodiments, shear modules 34 may be pre-formed and incorporated into the remaining portions of shear band 22, which, thereafter, may be incorporated into tire 12, for example, via molding.

For example, shear modules 34 may be formed by wrapping (e.g., spirally) module reinforcement cord 50 around a mandrel to create a tube (or other configuration) formed by module reinforcement cord 50. Thereafter, a polymer material (e.g., polyurethane or similar material) may be applied around module reinforcement cord 50 to form separator 44. Thereafter, a second module reinforcement cord 50 may be wrapped (e.g., spirally) around separator 44. According to some embodiments, polymer (e.g., polyurethane or similar material) may be applied to the exposed surfaces one or both of module reinforcement cords 50, thereby encapsulating module reinforcement cords 50.

According to some embodiments, the polymer (e.g., polyurethane or similar material) of shear band 22 and/or shear modules 34 may be partially cured for complete curing when incorporated into other portions of tire 12. For example, the polymer of shear band 22 and/or shear modules 34 may be partially cured by heating for a predetermined time and temperature, so that the polymer remains partially reactive with a subsequently-supplied polymer that will be molded around the shear band 22 and/or shear modules 34. For example, for polyurethane urea systems using TDDM curative, this may be a temperature ranging from about 110° C. to about 150° C. for a duration ranging from about 2 hours to about 6 hours (e.g., at 130° C. for 4 hours). Thereafter, the partially cured shear band 22 and/or shear modules 34 may be added to a mold for forming other portions of tire 12, so that shear band 22 and/or shear modules 34 may be molded into the remaining portions of tire 12. Subsequently, after the polymer used to form the remainder of tire 12 has been added to the mold, the entire tire 12 including the shear band 22 and shear modules 34 may be completely cured to form the tire 12. For example, for polyurethane urea systems using TDDM as a curative, curing of the polymer of tire 12 may be performed by heating tire 12 at a temperature ranging from about 120° C. to about 160° C. for a duration ranging from about 6 hours to about 48 hours (e.g., at 140° C. for 24 hours). Thereafter, the completely cured tire may be removed from the mold.

According to some embodiments, tire 12 may be configured such that the axial width of tire 12 varies in a radial direction between hub 14 and tread portion 24. For example, tire 12 may have an inner axial width associated with inner circumferential barrier 16 (e.g., adjacent hub 14) and an outer axial width associated with shear band 22 (e.g., adjacent tread portion 24), where the outer axial width is greater than the inner axial width. For example, the ratio of the outer axial width to the inner axial width may range from 1:1 to 3.5:1. In some embodiments, the ratio of the outer axial width to the inner axial width may range from 1.2:1 to 3.5:1, for example, from 1.4:1 to 2.8:1. According to some embodiments, the radial cross-section of tire 12 between hub 14 and tread portion 24 defines a trapezoid. According to some embodiments, the axial width of tire 12 may not vary significantly between hub 14 and tread portion 24, for example, as shown in FIGS. 1 and 4.

Tire 12 may have dimensions tailored to the desired performance characteristics based on the expected use of the tire. For example, tire 12 may have a width at tread portion 24 ranging from 0.1 meter to 2 meters (e.g., 1 meter), an inner diameter for coupling with hub 14 ranging from 0.5 meters to 4 meters (e.g., 2 meters), and an outer diameter ranging from 0.75 meter to 6 meters (e.g., 4 meters). According to some embodiments, the ratio of the inner diameter of tire 12 to the outer diameter of tire 12 ranges from 0.25:1 to 0.75:1, or 0.4:1 to 0.6:1, for example, about 0.5:1. Tire 12 may have an axial width ranging from 0.05 meter to 3 meters. Other dimensions are contemplated. For example, for smaller machines, correspondingly smaller dimensions are contemplated.

### INDUSTRIAL APPLICABILITY

The non-pneumatic tires disclosed herein may be used with any machines, including self-propelled vehicles or vehicles intended to be pushed or pulled by another machine. According to some embodiments, the non-pneumatic tires disclosed herein may overcome or mitigate potential drawbacks associated with prior non-pneumatic tires.

For example, relative to prior non-pneumatic tires, the non-pneumatic tires disclosed herein may be relatively lighter in weight than other non-pneumatic tires designed to support similar loads, and/or may have an ability to provide a desired level of cushioning, regardless of whether the load on the tire changes significantly. This may be desirable when non-pneumatic tires are installed on machines that carry loads of widely varying magnitude. For example, the tires of a wheel loader or haul truck may be subjected to a relatively light load when not carrying a load of material, but a relatively high load when carrying a load of material. The non-pneumatic tires disclosed herein may be able to provide a desirable level of cushioning and/or traction in both conditions. In addition, at least some embodiments of the non-pneumatic tires disclosed herein may be relatively more durable due to the configuration of the shear band and/or shear modules. The exemplary shear band and/or shear modules disclosed herein may prevent or reduce the likelihood of the support structure collapsing when loaded, which, in turn, may increase the service life of the tire.

It will be apparent to those skilled in the art that various modifications and variations can be made to the exemplary disclosed tires and wheels including the tires. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A non-pneumatic tire comprising:
an inner circumferential barrier configured to be associated with a hub;
an outer circumferential barrier radially exterior relative to the inner circumferential barrier;
a plurality of spokes extending between the inner circumferential barrier and the outer circumferential barrier; and
a shear band radially exterior relative to the outer circumferential barrier and radially interior relative to a tread portion of the tire, the shear band including:
an internal tension band associated with the outer circumferential barrier, wherein the internal tension band extends circumferentially around the outer circumferential barrier and includes at least one circumferentially extending reinforcement cord,
an external compression band radially spaced from and exterior relative to the internal tension band, wherein the external compression band includes at least one circumferentially extending reinforcement cord, and
at least one shear module extending between a radially external surface of the internal tension band and a radially internal surface of the external compression band, the at least one shear module including:
a first reinforcement element;
a second reinforcement element; and
a separator between the first reinforcement element and the second reinforcement element.

2. The tire of claim 1, wherein at least one of the first reinforcement element and the second reinforcement element includes at least one module reinforcement cord.

3. The tire of claim 2, wherein the at least one module reinforcement cord includes a plurality of module reinforcement cords.

4. The tire of claim 2, wherein the at least one module reinforcement cord includes a wire rope including a plurality of spirally-wrapped wires.

5. The tire of claim 1, wherein the at least one shear module includes a plurality of the shear modules, and wherein the plurality of shear modules are positioned circumferentially about the tire.

6. The tire of claim 5, wherein the plurality of the shear modules are circumferentially spaced from one another about the tire.

7. The tire of claim 5, wherein at least some circumferentially adjacent shear modules contact one another.

8. The tire of claim 5, wherein the shear modules are tubular and have a longitudinal axis extending transverse to an equatorial plane of the tire perpendicular to an axis of rotation of the tire.

9. The tire of claim 8, wherein the first reinforcement element is exterior relative to the separator, and the second reinforcement element is interior relative to the separator.

10. The tire of claim 9, wherein at least one of the first reinforcement element and the second reinforcement element is encapsulated.

11. The tire of claim 9, wherein at least one of the first reinforcement element and the second reinforcement element includes at least one module reinforcement cord, and wherein the at least one module reinforcement cord is spirally-oriented with respect to the separator.

12. The tire of claim 8, wherein the shear modules have a cross-section parallel relative to the equatorial plane, and the cross-section is one of circular, elliptical, square-shaped, and polygonal-shaped.

13. The tire of claim 1, wherein the at least one shear module intermittently contacts the radially external surface of the internal tension band and the radially internal surface of the external compression band.

14. The tire of claim 13, wherein the at least one shear module forms a waveform as it extends between the radially external surface of the internal tension band and the radially internal surface of the external compression band, and the waveform includes at least one of a sine waveform, a square waveform, and a triangular waveform.

15. The tire of claim 1, wherein each of the plurality of spokes extends radially.

16. The tire of claim 15, wherein the at least some of the plurality of spokes are located at different axial locations.

17. The tire of claim 1, wherein at least one of the inner circumferential barrier, the outer circumferential barrier, the plurality of spokes, the internal tension band, the external compression band, the at least one shear module, and the tread portion is at least partially formed from at least one polymer selected from the group consisting of polyurethane, natural rubber, synthetic rubber, and combinations thereof.

18. A wheel comprising:
a hub configured to be coupled to a machine; and
a non-pneumatic tire coupled to the hub, the non-pneumatic tire including:
an inner circumferential barrier coupled to the hub;
an outer circumferential barrier radially exterior relative to the inner circumferential barrier;
a plurality of spokes extending between the inner circumferential barrier and the outer circumferential barrier; and
a shear band radially exterior relative to the outer circumferential barrier and radially interior relative to a tread portion of the tire, the shear band including:
an internal tension band associated with the outer circumferential barrier, wherein the internal tension band extends circumferentially around the outer circumferential barrier and includes at least one circumferentially extending reinforcement cord,
an external compression band radially spaced from and exterior relative to the internal tension band, wherein the external compression band includes at least one circumferentially extending reinforcement cord, and
at least one shear module extending between a radially external surface of the internal tension band and a radially internal surface of the external compression band, the at least one shear module including:
a first reinforcement element;
a second reinforcement element; and
a separator between the first reinforcement element and the second reinforcement element.

19. The wheel of claim 18, wherein the at least one shear module includes a plurality of the shear modules, and wherein the plurality of shear modules are positioned circumferentially about the tire.

20. The wheel of claim 18, wherein the at least one shear module intermittently contacts the radially external surface of the internal tension band and the radially internal surface of the external compression band.
